(19) United States
(12) Patent Application Publication
(10) Pub. No.: US 2026/0064453 A1
(43) Pub. Date: Mar. 5, 2026

(54) TRANSIENT VIRTUAL MACHINES FOR OBTAINING AND TESTING FREE AND OPEN SOURCE SOFTWARE IN AN ENTERPRISE COMPUTING ENVIRONMENT

(71) Applicant: The PNC Financial Services Group, Inc., Pittsburgh, PA (US)

(72) Inventors: Kevin Black, Pittsburgh, PA (US); Garrett Scherba, Medina, OH (US); Michael Degnan, Pittsburgh, PA (US); Jay Yobbagy, Weirton, WV (US); Patrick Slayden, Independence, MO (US); Brian Stoneburner, Marietta, SC (US); Adam Hodge, Cleveland, OH (US); Norman Alfano, Olmsted Falls, OH (US)

(21) Appl. No.: 18/897,930

(22) Filed: Sep. 26, 2024

Related U.S. Application Data
(60) Provisional application No. 63/687,892, filed on Aug. 28, 2024.

(51) Int. Cl. G06F 9/455; H04L 9/40

(52) U.S. Cl. CPC G06F 9/45558; H04L 63/02; G06F 2009/4557; G06F 2009/45587; G06F 2009/45595

(57) ABSTRACT

Computer-implemented systems and methods provision a virtual machine sandbox for evaluating software. Firewall means are provisioned for a cloud network to permit access to an internet site from which source code is downloadable. A client computer device, via virtualization, controls a virtual machine. The client computer device is on an on-premises network that is different from, and in communication with, the cloud network. The virtual machine is controlled to: (a) download to the virtual machine, via the firewall means, the source code from the internet site; and (b) execute the source code for evaluation of the source code. The virtual machine is deleted after a predetermined time period. The source code is prohibited, after provisioning the virtual machine and through deletion of it, from being downloaded from the virtual machine to computer devices on the on-premises network.

### PRIORITY CLAIM

The present application claims priority to, and incorporates herein by reference, United States provisional patent application Ser. No. 63/687,892, filed Aug. 28, 2024, titled “TRANSIENT VIRTUAL MACHINES FOR OBTAINING AND TESTING FREE AND OPEN SOURCE SOFTWARE IN AN ENTERPRISE COMPUTING ENVIRONMENT.”

### BACKGROUND

Open source software (OSS) is software that is released with a license that allows anyone to view, use, modify, and distribute the source code. This contrasts with proprietary software, where the source code is typically closed, and users are restricted in how they can use or modify the software. By using OSS, companies can avoid the licensing fees associated with proprietary software. While OSS offers some advantages over proprietary software, there are also some potential downsides. For example, companies must ensure compliance with OSS licenses, which can be complex and varied. Violations can result in legal issues and financial penalties. Also, integrating OSS into proprietary software can create risks of IP contamination, potentially affecting the organization's ability to protect its own intellectual property. Further, the quality of OSS can vary widely. For example, some OSS programs can expose vulnerabilities that if not addressed by the user can pose security risks.

Due to the issues with OSS, sophisticated organizations often implement OSS policies that require a review of OSS prior to installing the OSS in the organization's operating environments. In large organizations, the OSS review panel might receive hundreds of requests for OSS from its developers per month, and the review process is cumbersome from a time and resource perspective. This can discourage developers in the organization from experimenting with OSS for the organization, thereby diminishing the organization's ability to experience the potential benefits of OSS.

### SUMMARY

One general aspect of the present invention is directed to computer-implemented systems and methods where a sandbox virtual machine, in a cloud computing environment, is used to evaluate OSS for an organization. There is a proverbial air-gap between the sandbox virtual machine and the organization's trusted (e.g., on-premises) network such the OSS is prevented from being downloaded or otherwise migrated to computers in the organization's trusted network. The system can also include a firewall such that the sandbox virtual machine can only access certain, “whitelisted” external internet resources for downloading the OSS source code to be evaluated. That limits the sources from which OSS can be downloaded to the organization's cloud environment for evaluation, which provides an additional layer of network security for the organization.

The sandbox virtual machine to which the OSS is downloaded can be deleted (e.g., automatically or manually) after a fixed, predetermined time period, such as a number of days.

This further mitigates the likelihood of the OSS leaking to the organization's on-premises network. If the evaluation of the OSS is not completed within the time period prior to deletion of the sandbox virtual machine, a new sandbox virtual machine can be provisioned for further testing of the OSS, but it too is preferably deleted after its time period expires. In some embodiments, no data or files from the sandbox virtual machine are retained other than log data for the sandbox virtual machine.

Embodiments of the present can provide an organization (e.g., a company) with a way to test FOSS without infecting the organization's trusted computer network. Also, the VMs where the FOSS is tested are time limited, thereby further mitigating potential infection of the organization's trusted network. These and other potential benefits that can be realized through embodiments of the present invention will be apparent from the description below.

### FIGURES

Various aspects of the present invention described herein, both as to organization and methods of operation, together with further objects and advantages thereof, may best be understood by reference to the following description, taken in conjunction with the accompanying drawings as follows.

FIG. 1 is a high-level block diagram of a networked computer system including transient virtual machines for obtaining and testing free and open source software (FOSS) according to an exemplary embodiment of the disclosure.

FIG. 2 is a flow chart of a method for requesting an instantiation of, instantiating, using, and finally destroying a FOSS sandbox virtual machine according to an exemplary embodiment of the disclosure.

### DESCRIPTION

In part, in one aspect, the present invention relates to a networked computer system operable to create, use, and destroy virtual machines for the evaluation of free and open source software (FOSS) or other software from a remote host in a trusted, insulated network.

In part, in one aspect, the present invention relates to a method for the creation, use, and destruction of FOSS sandbox virtual machines.

Before explaining various aspects of various systems and methods disclosed herein, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects and/or examples.

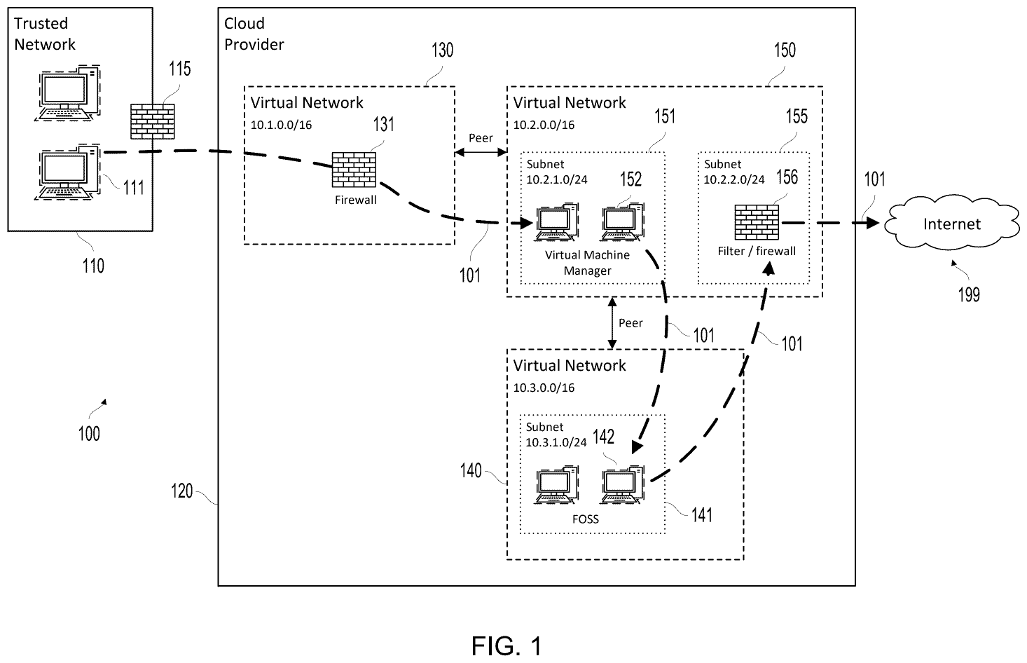

Refer now to FIG. 1, wherein a high-level block diagram of a networked computer system 100 for an organization, where the computer system 100 includes transient virtual machines for obtaining and testing free and open source software (FOSS) for use by the organization, is shown. The networked computer system 100 comprises a trusted, insulated (e.g., on-premises) network 110 and a cloud provider 120 or other network that mediates access to an untrusted, external network 199, such as the Internet. The cloud provider could be Azure or some other suitable cloud environment provider. Computing resources provided by the cloud provider 120 or other network comprise various virtual machines in various virtual networks or network address spaces. These various virtual machines in various virtual networks or network address spaces provide a path 101 from an origin machine 111 in the trusted network 110, to a virtual machine manager 152 in the cloud provider network 120, to a FOSS sandbox machine 142 also in the cloud provider network 120, to a final filter or firewall 156 also in the cloud provider network 120, and finally to the Internet 199, which is external to the cloud provider network 120. The origin machine 111 and the trusted network 110 remain insulated from the Internet, and the FOSS sandbox virtual machine 142 is only accessed via the virtual machine manager 152.

In the high-level diagram of FIG. 1, computing resources provided by the cloud provider 120 comprise a first virtual network 130, a second virtual network 140, and a third virtual network 150. The first virtual network 130 can provide a gateway to remaining computing resources provided by the cloud provider 120 and may comprise a firewall 131 or other network traffic filter. The second virtual network 140 can comprise at least one subnet 141 that in turn comprises at least one FOSS sandbox virtual machine 142. A “subnet” in this context can be a subnetwork, e.g., a logical subdivision of an IP network, such as the cloud provider network 120. Subnetting divides an IP address space into multiple smaller segments. Each subnet operates as a separate, smaller network within a larger network. An IP address consists of a network portion and a host portion. Subnetting allows the boundary between these portions to be altered, effectively increasing or decreasing the number of networks or hosts available. A subnet mask can be used to determine which portion of an IP address is the network address and which is the host address.

In most embodiments, a FOSS sandbox virtual machine 142 is both instantiated and destroyed by the virtual machine manager 152. In many embodiments, a FOSS sandbox virtual machine 142 may have a finite lifetime, and data associated with the FOSS sandbox virtual machine 142 may not persist on any other computing resource provided by the cloud provider 120 (or the trusted network 110) after the FOSS sandbox virtual machine 142 has been destroyed. In some embodiments, the finite lifetime of a FOSS sandbox virtual machine 142 may be a time period of several days, such as at least 3 days and no more than 7 days, and more particularly 5 days in some embodiments. In other embodiments, only logging information or metadata from a FOSS sandbox virtual machine 142 may be retained (e.g., in a database of the cloud provider network 120) after the virtual machine 142 has been destroyed.

The third virtual network 150 comprises a first subnet 151 that in turn comprises a virtual machine manager 152. The third virtual network 150 further comprises a second subnet 155 that in turn comprises a final firewall 156 or another network filter. In many embodiments, subnets within a virtual network are addressable by any other subnet within the same virtual network. For example, the first subnet 151 of the third virtual network 150 is addressable by the second subnet 155 of the third virtual network 150, and vice versa. In many embodiments, the first virtual network 130 is a network peer of the third virtual network 150, but not of the second virtual network 140, and as such, virtual machines or hosts within the third virtual network are addressable by virtual machines in the first virtual network, but virtual machines or hosts in the second virtual network are not addressable by virtual machines or hosts in the first virtual network. Similarly, the second virtual network is a network peer of the third virtual network, and as such, virtual machines or hosts in the second virtual network are addressable only by virtual machines or hosts in the third virtual network. In many embodiments isolation of various virtual networks or subnets may be important to network security and ensuring that only trusted actors are materials interact with the trusted network 110.

In the embodiment of FIG. 1, subnet address ranges or prefixes for the variously depicted subnets 141, 151, 155, such as 10.1.0.0/16, 10.3.1.0/24, etc. are only used as examples.

In many embodiments, such as the embodiment of the network structure depicted in the high-level block diagram of FIG. 1, the origin machine 111 can, via the path 101 and the virtual machine manager 152, instantiate a FOSS sandbox virtual machine 142, load FOSS or other software on the FOSS sandbox virtual machine from the Internet 199, test and evaluate the FOSS or other software, and then destroy the FOSS virtual machine.

In some embodiments, a connection to a FOSS sandbox virtual machine from an origin machine 111 may be initiated via a remote shell protocol, such as secure shell (SSH), or via a graphical remote connection protocol, such as remote desktop protocol (RDP). In some embodiments, when a graphical remote connection protocol is used to connect to a FOSS sandbox virtual machine, various security controls may be implemented to protect the insulated, trusted network 110. For example, a feature for copying and pasting any text to or from a graphical environment when connected via a graphical remote connection protocol may be disabled.

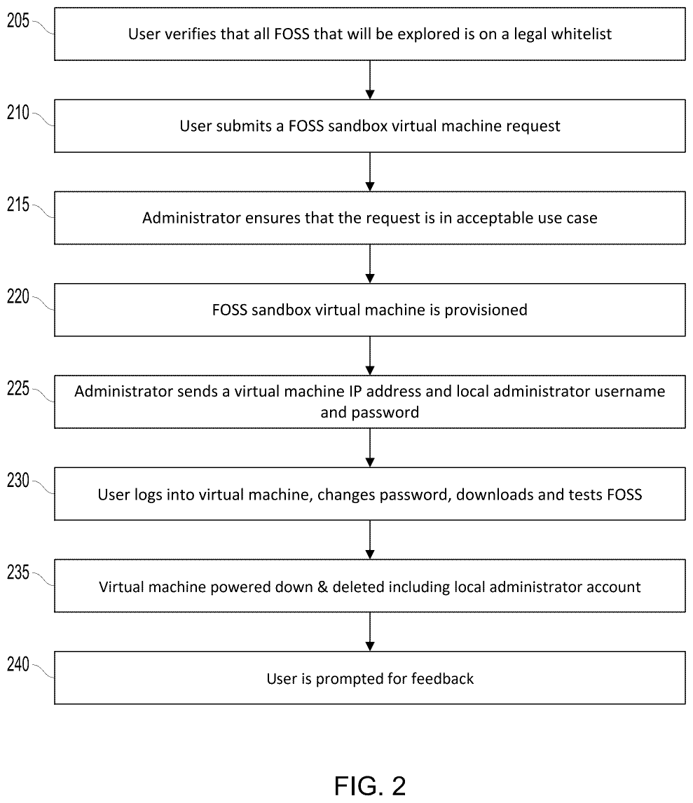

Refer now to the example embodiment of FIG. 2, wherein a flow chart of a method for requesting an instantiation of instantiating (e.g., creating), using, and finally destroying a FOSS sandbox virtual machine is shown. The flow chart in FIG. 2 depicts a sequence of steps. In many embodiments, a first step 205 in the method comprises a user within the organization associated with the trusted network 110, such as a user of the machine 111, verifying that the FOSS that will be explored exists in a whitelist, such as a whitelist of websites (e.g., URLs) available on the Internet 199 via the firewall 156 for downloading or otherwise accessing the FOSS for evaluation. This step can be performed, for example, as part of an online web form that the user fills out as part of the request to evaluate FOSS that is available on the Internet 199.

A second step 210 comprises a user submitting a request, such as to a network administrator for the trusted network 110, to instantiate a FOSS virtual machine. Again, this step can be part of an online form that the user submits to the organization's network administrator as part of the FOSS evaluation request process.

A third step 215 comprises the administrator ensuring that the request constitutes an acceptable use case for the FOSS, such as in accordance with guidelines and/or policies of the organization with respect to use of FOSS. If the use case is acceptable and the user's request is approved, the network administrator can update the firewall 199 so that the virtual machine 142, once created, can access the website for the FOSS if the firewall is not already so provisioned.

In that sense, the firewall 199 can act as a “whitelist” firewall, such that it only explicitly permits traffic to certain websites/URLs, i.e., the ones on the “whitelist,” and blocks traffic to all other websites/URLs. The firewall 199 can be configured by default to deny all incoming and outgoing traffic from the Internet 199. This means that unless there is a specific rule that permits the traffic, it will be blocked. If the approved internet source that the user seeks to access is not on the whitelist already, the network administrator can create a specific rule for the firewall 199 that allow traffics from the trusted sources. The rule can specify the IP addresses, ports, and protocols that are allowed to pass through the firewall 199.

If the use case is unacceptable according to the organization's policies, the administrator can reject the request. In response, the organization's systems may allow the user to update the request to address any issues that cause the rejection or to withdraw the request.

A fourth step 220 comprises provisioning of the network and computing resources for the FOSS sandbox virtual machine 142 and instantiating the virtual machine. This can involve, for example, the network administrator launching the virtual machine manager 152 and connecting to the host machine that will run the new FOSS sandbox virtual machine 142. A number of installation types for the FOSS sandbox virtual machine 142 might be available, such as installing from an ISO/image file, installing from a network boot, and/or installing from an existing disk. Via the virtual machine manager 152, the administrator can specify a name for the new FOSS sandbox virtual machine 142 and specify the storage location for the virtual machine files. The administrator can also configure, via the virtual machine manager 152, the hardware for the FOSS sandbox virtual machine 142, such as the memory (e.g., amount of RAM), number of CPU cores, virtual hard disks, and/or network interfaces (NAT, bridged, host-only, etc.). The provisioning process can also include installing an operating system for the FOSS virtual machine 152 and installing any desired tools and drivers.

The FOSS sandbox virtual machine 142 such that it can only communicate with the firewall 199 to access the Internet 199 and with servers on the virtual network subnet 151. That way, machines on the trusted network 110 are prevented from accessing the FOSS sandbox virtual machine 142, except virtually via the path 101. That way the FOSS, once downloaded to the FOSS sandbox virtual machine 142, is prevented from being downloaded to machines in trusted network via servers in the subnet 151. For example, the servers in the subnet 151 can be implemented with High Availability Infrastructure (HAI) servers (e.g., so-called high availability network endpoints), that can, among other things, control network traffic to and from the FOSS sandbox virtual machine 142. The HAI servers can be configured to act as routers or switches and can host firewall applications to monitor and control incoming and outgoing network traffic based on predetermined security rules directing network traffic to and from the FOSS sandbox virtual machine 142. The HAI servers may comprise, for example, VMware Horizon HAI servers, where VMware Horizon is a platform that delivers virtual desktops and applications through a unified framework.

Still further, the subnet 151 and the FOSS sandbox virtual machine 142 can use Network Security Group (NSG) security rules that allow or deny network traffic to and from network interfaces (NICs), virtual machines (VMs), or other resources within a cloud environment. NSGs consist of a list of rules that define what traffic is allowed or denied. These rules can be applied to network interfaces or subnets and can be configured based on: Source IP address or range; Destination IP address or range; Source port or range; Destination port or range; and/or Protocol (TCP, UDP, etc.). NSGs typically have two sets of rules: inbound rules, which control traffic coming into a resource; and outbound rules, which control traffic leaving a resource. Using NSG rules, the FOSS sandbox virtual machine 142 can be prevented from communicating with resources other than the subnet 151 and the firewall 156, thereby preventing the user at machine 111 from downloading the FOSS to a machine on the trusted network 110.

A fifth step 225 comprises the administrator sending a network address and login credentials of the instantiated virtual machine 142 to the user. The credentials can be sent to the user via email at the user's organization email and the email can include instructions for how the user can access the FOSS sandbox virtual machine 142. These credentials, which are preferably different from the user's credentials to log into the trusted network 110, allow the user, from the machine 111, to access the FOSS sandbox virtual machine 142 to, for example, access the Internet 199 via the firewall 156 to download the desired FOSS and then evaluate the FOSS to determine whether it can or should be used in the organization's computer systems. The user's evaluation can include an evaluation of the FOSS's performance and functions, and how they could be used by or within the user's organization. Downloading the FOSS in this context refer to and/or includes downloading the source code for the FOSS and then evaluating that source code.

A sixth step 230 comprises the user's logging into the virtual machine 142, executing any initial administrative tasks such as a changing of a password, and finally downloading and testing desired FOSS from the Internet 199, such as the URL for it permitted by the firewall 156. A user's logging into the virtual machine 142 may be initiated from the machine 111 via a remote shell protocol, such as secure shell (SSH), or via a graphical remote connection protocol, such as remote desktop protocol (RDP). In various embodiments, the user requires an organizational entitlement to access the FOSS virtual machine, which entitlements can be stored in an entitlements database for the organization. When the user attempts to access the FOSS virtual machine, the user's entitlements, as stored in the entitlements database, to verify whether the user is entitled to access it. The user may also need to install a virtual machine client (e.g., virtualization software) on his/her local machine 111. The vm client can allow the user, from the machine 111, to connect to, control, and interact with virtual machines, such as the FOSS sandbox virtual machine 142. The vm client can provide a graphical or command-line interface for the user to perform various tasks related to the FOSS sandbox virtual machine 142.

A seventh step 235 in the method comprises, after the user evaluates the FOSS, a powering down and deleting (e.g., either automatically or manually) of the virtual machine 142 and any computing resources or local storage associated with the virtual machine. For example, via the virtual machine manager 152, the network administrator can shut down the FOSS sandbox virtual machine 142 and store any data that is desired to be stored in a data storage of the cloud provider network 120. As mentioned previously, in some embodiments, no data are stored; in other embodiments, only log data are stored. Such log data can comprise, for example, system logs (events related to the operating system running inside the VM, such as boot sequences, system errors, warnings, and informational messages), security logs (records of login attempts, both successful and failed, as well as other authentication-related events), performance and resource usage logs (data on CPU, memory, disk, and network usage over time), VM lifecycle logs, migration logs, hypervisor performance logs, user activity logs, and/or configuration logs. In yet other, less-preferred embodiments additional data can be stored, such as test data, output data, user interaction data, evaluation nodes, integration test data, VM snapshots, backup data, etc. The network administrator, from the virtual machine manager, can then delete the FOSS sandbox virtual machine 142. This can include deleting any virtual hard disks associated with the FOSS sandbox virtual machine 142. The de-commissioning of the FOSS sandbox virtual machine 142 can also include releasing or deallocating IP addresses associated with the FOSS sandbox virtual machine 142. The FOSS sandbox virtual machine 142 could also be deleted automatically, such as via command-line tools or a script that triggers (e.g., via vSphere PowerCLI or APIs) automatic deletion of the FOSS sandbox virtual machine 142 at the expiration time.

Finally, an eighth step 240 comprises prompting a user to provide feedback via the FOSS that the user evaluated. The feedback process can be automated by the organization's systems once the evaluation time period for the FOSS evaluation (e.g., 5 days) has expired. The feedback request can be sent to the user via email, where the email has a link to an online form where the user provides the feedback.

Based on the evaluation, the user could submit (e.g., via an online form available within the organization) a formal request for the firm to license the FOSS. If the organization approves the request, the FOSS could then be downloaded to one or more computers within the organization's trusted network 110 for use (with appropriate modification) in production in one or more of the organization's software systems.

In various embodiments, if the user has not completed the evaluation within the allotted evaluation period (e.g., 5 days), instead of extending the duration of the FOSS sandbox virtual machine 142, the user can reinitiate the process of FIG. 2 to set up a new FOSS virtual machine to evaluate further the FOSS. Putting a time limit on the FOSS sandbox virtual machine 142 further mitigates the likelihood that the FOSS leaks into or otherwise infects the trusted network's machines.

The above-description referred to an “administrator” performing various tasks in the process. The administrator could be a single person or a team of people, or even a group of people across various teams at the organization.

The firewall 199 can be embodied as a virtual appliance or a software-defined firewall, which runs on virtual machines (VMs) within the cloud provider's infrastructure. A virtual firewall appliance is a virtual instance of a traditional firewall, such as those from vendors like Cisco, Palo Alto Networks, or Check Point, which is deployed within a cloud environment (e.g., AWS, Azure, Google Cloud). These virtual appliances operate similarly to physical firewalls but run on cloud infrastructure.

In other embodiments, the firewall 199 can be implemented with cloud security services available from Zscaler, which services can include secure web gateways, firewall as a service, cloud access security broker (CASB), and zero trust network access (ZTNA). These services are designed to secure user traffic and data without relying on traditional hardware-based security appliances. Instead, Zscaler routes traffic through its global cloud infrastructure, which inspects and secures the traffic in real-time. For example, a gateway in cloud network 120, acting as part of the firewall 199, could be configured to direct traffic to the nearest Zscaler data center. This can be done using methods like PAC files or DNS forwarding, for example.

Once the traffic reaches the Zscaler cloud, it is inspected by Zscaler's SWG. This includes URL filtering, SSL inspection, threat detection, data loss prevention (DLP), and more. Zscaler enforces security policies based on user identity, location, and other contextual factors. Zscaler's Firewall as a Service (FWaaS) can inspect traffic at the network level. It can enforce traditional firewall rules, such as allowing or blocking specific IP addresses (e.g., blocking the IP addresses not on the whitelist for the FOSS internet sources or repositories), ports, or protocols. The organization's DNS can be configured to resolve certain traffic (e.g., internet-bound) through Zscaler.

The various virtual machines and appliances in the cloud provider network 120 can be embodied as software-based abstractions that run on physical hardware. The cloud network 120 may comprise a large number of physical servers housed in data centers. These servers can be equipped with powerful CPUs, ample memory, storage, and networking capabilities. On these physical servers, a hypervisor (or Virtual Machine Monitor, VMM) can be installed. The hypervisor is software that creates and manages multiple virtual machines on a single physical server. It abstracts the hardware resources and allocates them to VMs. Each VM can be an isolated environment with its own operating system and applications. The hypervisor provides virtualized hardware to the VM, such as virtual CPUs, memory, and storage, making the VM appear to have its own dedicated hardware resources. The cloud network 120 can also comprise virtual appliances, which can be pre-configured virtual machines designed for specific purposes, such as security or network functions. Virtual appliances typically come with software and settings already in place and can be deployed as a single unit in the cloud. The cloud network 120 can also include virtual storage and networking components. Virtual disks and storage are used by VMs to store data, while virtual networks connect VMs and manage traffic. The cloud network 120 can use management and orchestration tools to handle the deployment, scaling, and monitoring of VMs and virtual appliances. These tools ensure efficient resource utilization and automate various administrative tasks.

The embodiments described above referred in places to a user completing an online form to request access to the FOSS for evaluation. An organization could employ in other embodiments, additionally or alternatively, other mechanisms by which a developer could request access to the FOSS for evaluation, such as template emails, chatbot or messaging platform integration, a command-line interface tool, and/or an API-based system, for example. For instance, in an API-based system, an internal API could be developed where developers can send requests programmatically. The API could validate the requests, check compliance with organization policies, and either approve access automatically or escalate to an administrator.

Also, if the organization uses a CI/CD pipeline or other automated systems, webhooks can be triggered when a developer requests access. These webhooks could interact with the API or other systems to process the request.

The embodiments described above were described in places in the context of FOSS, although it should be recognized that the sandbox virtual machine 142 could be used to evaluate non-free OSS and/or software that is not open source, such a proprietary software, shareware, non-open source freeware, etc. In a like manner, a user, via the sandbox virtual machine 142, could download such non-FOSS source code to the sandbox virtual machine 142 to evaluate the non-FOSS source code, provided that the firewall 156 is configured to allow access to the source of the non-FOSS source code.

In various embodiments, interactions between a user and an administrator, such as a user's requesting an instantiation of a FOSS sandbox virtual machine or an administrator's sending of a network address and login credentials of the instantiated virtual machine to the user may be conducted in a project tracking system or ticket-based issue management system.

In one general aspect, therefore, the present invention is directed to computer-implemented systems and methods for provisioning a virtual machine sandbox for evaluating software, e.g., source code, such as open source software. A method according to embodiments of the present invention comprises the step of provisioning firewall means for a cloud network to permit access to an internet site from which source code is downloadable. The method also comprises the step of provisioning a virtual machine on the cloud network. The method also comprises the step of controlling, by a client computer device, via virtualization, the virtual machine, where: (1) the client computer device is on an on-premises network that is different from, and in communication with, the cloud network; and (2) controlling the virtual machine comprises controlling the virtual machine to: (a) download to the virtual machine, via the firewall means, the source code from the internet site; and (b) execute the source code for evaluation of the source code. The method further comprises the steps of: deleting the virtual machine after a predetermined time period; and prohibiting, after provisioning of the virtual machine and through deletion of the virtual machine, by one or more servers on the cloud network, the source code from being downloaded from the virtual machine to computer devices on the on-premises network.

A system according to various embodiments of the present invention comprises an on-premises network and a cloud network in communication with the on-premises network. The on-premises network comprises a client computer device that comprises virtualization software.

The cloud network comprises: firewall means that permit access from the cloud network to an internet site from which source code is downloadable; and a virtual machine on the cloud network; and a subnet comprising one or more servers. The one or more servers of the subnet execute a virtual machine manager for provisioning the virtual machine. The virtual machine is controllable, via virtualization, by the client computer device to: download to the virtual machine, via the firewall means, the source code from the internet site; and execute the source code for evaluation of the source code. The virtual machine manager is configured to delete the virtual machine (e.g., automatically or manually) after a predetermined time period. And the subnet prohibits, after provisioning of the virtual machine and through deletion of the virtual machine, the source code from being downloaded from the virtual machine to computer devices on the on-premises network.

In various implementations, the source code comprises free open source software.

Also, the predetermined time period can be at least 3 days and no more than 7 days, such as 5 days.

In various implementations, the firewall means comprises a gateway on the cloud network that is in communication with a data center that provides firewall services for the cloud network. In various implementations, the firewall means only permit access from the cloud network to internet sites on a whitelist and prohibits access from the cloud network to internet sites that are not on the whitelist.

In various implementations, the client computer device comprises virtualization software for controlling the virtual machine.

In various implementations, the method further comprises the steps of: receiving, by an administrator, from a user of the client computer device, a request to access the internet site to download and evaluate the source code; and upon approving the request by the administrator, and after provisioning the virtual machine, transmitting, from the administrator to the user of the client computer device, login credentials for the virtual machine.

In various implementations, the one or more network servers that prohibit the source code from being downloaded from the virtual machine to computer devices on the on-premises network comprise a high availability network endpoint.

In various implementations, the method further comprises the step of storing, in a data store of the cloud network, after deletion of the virtual machine, log data for the virtual machine.

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” “an embodiment,” “one embodiment,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method comprising:
provisioning firewall means for a cloud network to permit access to an internet site from which source code is downloadable;
provisioning a virtual machine on the cloud network;
controlling, by a client computer device, via virtualization, the virtual machine, wherein:
the client computer device is on an on-premises network that is different from, and in communication with, the cloud network; and
controlling the virtual machine comprises controlling the virtual machine to:
download to the virtual machine, via the firewall means, the source code from the internet site; and
execute the source code for evaluation of the source code;
deleting the virtual machine after a predetermined time period; and
prohibiting, after provisioning of the virtual machine and through deletion of the virtual machine, by one or more servers on the cloud network, the source code from being downloaded from the virtual machine to computer devices on the on-premises network.

2. The method of claim 1, wherein the source code comprises free open source software.

3. The method of claim 1, wherein the predetermined time period is a time period that is at least 3 days and no more than 7 days.

4. The method of claim 3, wherein the predetermined time period is 5 days.

5. The method of claim 1, wherein the firewall means comprises a gateway on the cloud network that is in communication with a data center that provides firewall services for the cloud network.

6. The method of claim 1, wherein the firewall means only permit access from the cloud network to internet sites on a whitelist and prohibits access from the cloud network to internet sites that are not on the whitelist.

7. The method of claim 1, wherein the client computer device comprises virtualization software for controlling the virtual machine.

8. The method of claim 1, further comprising:
receiving, by an administrator, from a user of the client computer device, a request to access the internet site to download and evaluate the source code; and
upon approving the request by the administrator, and after provisioning the virtual machine, transmitting, from the administrator to the user of the client computer device, login credentials for the virtual machine.

9. The method of claim 1, wherein the one or more network servers that prohibit the source code from being downloaded from the virtual machine to computer devices on the on-premises network comprise a high availability network endpoint.

10. The method of claim 1, further comprising storing, in a data store of the cloud network, after deletion of the virtual machine, log data for the virtual machine.

11. A system comprising:
an on-premises network that comprises a client computer device, wherein the client computer device comprises virtualization software; and
a cloud network in communication with the on-premises network, wherein the cloud network comprises:
firewall means that permit access from the cloud network to an internet site from which source code is downloadable;
a virtual machine on the cloud network; and
a subnet comprising one or more servers,
wherein:
the one or more servers of the subnet execute a virtual machine manager for provisioning the virtual machine;
the virtual machine is controllable, via virtualization, by the client computer device to:
download to the virtual machine, via the firewall means, the source code from the internet site; and
execute the source code for evaluation of the source code;
the virtual machine manager is configured to delete the virtual machine after a predetermined time period; and
the subnet prohibits, after provisioning of the virtual machine and through deletion of the virtual machine, the source code from being downloaded from the virtual machine to computer devices on the on-premises network.

12. The system of claim 11, wherein the source code comprises free open source software.

13. The system of claim 11, wherein the predetermined time period is time period that is at least 3 days and no more than 7 days.

14. The system of claim 13, wherein the predetermined time period is 5 days.

15. The system of claim 11, wherein the firewall means comprises a gateway on the cloud network that is in communication with a data center that provides firewall services for the cloud network.

16. The system of claim 11, wherein the firewall means only permit access from the cloud network to internet sites on a whitelist and prohibits access from the cloud network to internet sites that are not on the whitelist.

17. The system of claim 11, wherein the one or more servers that prohibit the source code from being downloaded from the virtual machine to computer devices on the on-premises network comprise a high availability network endpoint.
